(19) United States
(12) Patent Application Publication
(10) Pub. No.: US 2003/0184054 A1
(43) Pub. Date: Oct. 2, 2003

(54) Frame of a cart for the handicapped

(76) Inventor: Arthur Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/096,432

(22) Filed: Mar. 13, 2002

(51) Int. Cl. B62B 1/00

(52) U.S. Cl. 280/651

(57) ABSTRACT

A frame of an electric cart for the handicapped includes a front part and a rear part. The front part has several parallel connecting tubes, and the rear part also has parallel connecting tubes each corresponding to one of the tubes of the front part. The front tubes are inserted into the rear tubes, and bolts are screwed into screw holes formed alongside the tubes such that the front part and the rear parts are joined together. The length of the frame can be changed by means of adjusting the position of the front part in relation to the rear part.

### BACKGROUND OF THE INVENTION

The present invention relates to a frame of a cart for the handicapped, more particularly a frame of a cart for the handicapped that can be adjusted in respect of the length to meet the needs of users of different body sizes and accord with the demands of regulations of different countries.

Referring to FIG. 7, a cart for the handicapped includes a frame 2, a pair of front wheels 21 fitted to the front portion of the frame 2, a pair of rear wheels 22 fitted to the rear portion of the frame 2, a motor 23, and a handle 24. A seat (not shown) is fitted to the frame 2 such that a person can ride on the cart, and be moved around with the motor 23 transforming electrical power into movement.

However, the manufacturers have to produce frames of various lengths to meet the needs of different users and accord with the regulations of different countries because the above frame is made in such a manner that it can't be adjusted in respect of the length. Therefore, the designing, manufacturing, and sorting frames of various sizes become a heavy burden on the cost and management.

### SUMMARY OF THE INVENTION

Therefore, it is a main object of the present invention to provide a frame of a cart for the handicapped, which includes a front part, and a rear part movably connected to the front part such that the length of the frame can be adjusted.

It is a second object of the present invention to provide a frame of a cart for the handicapped such that the same can be easily assembled, and the length thereof can be easily adjusted.

The frame of a cart for handicapped persons of the present invention includes a front part and a rear part. The front part has several parallel connecting tubes, while the rear part has parallel connecting tubes corresponding to the tubes of the front part.

The front connecting tubes are inserted into the rear connecting tubes with a desired length, and bolts are screwed through screw holes spaced along the rear connecting tubes and into through holes spaced along the front connecting tubes such that the front part and the rear part are joined together. Therefore, the length of the frame can be changed by means of adjusting the position of the front part in relation to the rear part.

### BRIEF DESCRIPTION OF THE DRAWINGS

The present invention will be better understood by reference to the accompanying drawings, wherein:

FIG. 1 is an exploded perspective view of a frame of a cart for the handicapped of the present invention.

FIG. 2 is a top view of the frame of the present invention.

FIG. 3 is a side view of the frame of the present invention.

FIG. 4 is a fragmentary view of the frame of the present invention.

FIG. 5 is a side view of the frame of the present invention with a reduced length.

FIG. 6 is a view of the second embodiment of the present invention.

FIG. 7 is a perspective view of the conventional cart frame in the Background.

### DETAILED DESCRIPTION OF THE PREFERRED EMBODIMENTS

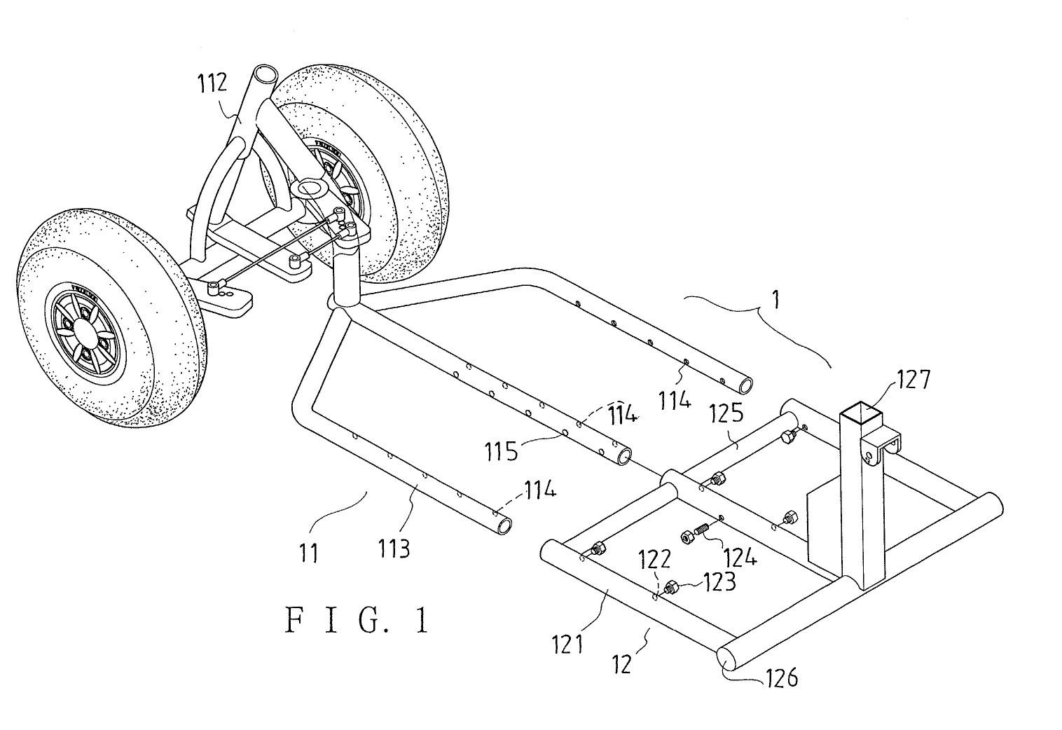

Referring to FIG. 1, a frame 1 of a cart for the handicapped of the present invention includes a front part 11 and a rear part 12. The front part 11 is connected to a support member 112, to which a handle (not shown), and two front wheels are fitted. A front part 11 of the cart body is connected to the support member 112 as shown in FIG. 3.

The front part 11 includes several connecting tubes 113, which are parallel to each other, and each of which are provided with several through holes 114 spaced therealong. One of the connecting tubes 113, e.g. the intermediate one in FIGS. 1 and 3, is provided with several spaced locating recesses 115 on the opposite side of the through holes 114.

The rear part 12 includes parallel connecting tubes 121 each corresponding to one of the connecting tubes 113 of the front part 11, a transverse support rod 126 connected to the rear ends of the connecting tubes 121, and an upright tube 127 sticking up from the rear end thereof. The connecting tubes 121 each has screw holes 122 at one side, which opposes the through holes 114 of the corresponding tube 113 when the connecting tube 113 is inserted thereinto in assembling the frame. A sea and a motor (not shown) are connected to the upright tube 127, and the middle portion of the rear part 12 respectively, and rear wheels (not shown) are fitted to two ends of the transverse rod 126.

Furthermore, the intermediate one of the connecting tubes 121 is provided with a through hole on the opposite side of the screw holes 122, into which an elastic button 124 is fitted. The elastic button 124 is provided at such a position that the through holes 114 of the front part 11 will exactly oppose the screw holes 122 of the rear part 12 when the elastic button 124 fits onto one of the locating recesses 115 of the front part 11 in assembling of the frame 1.

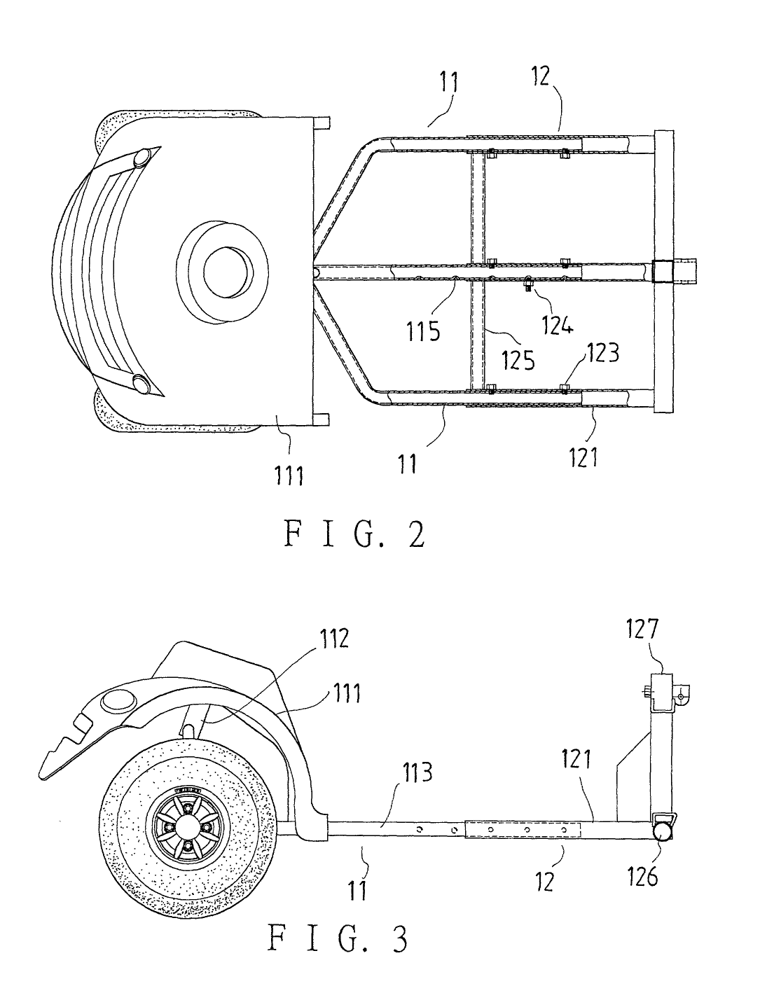

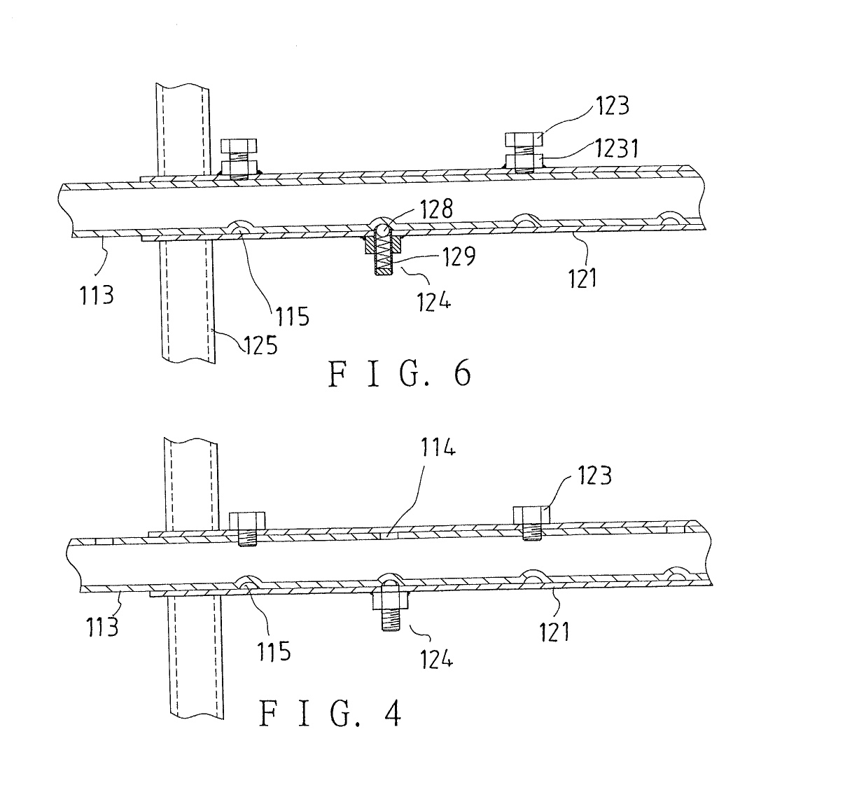

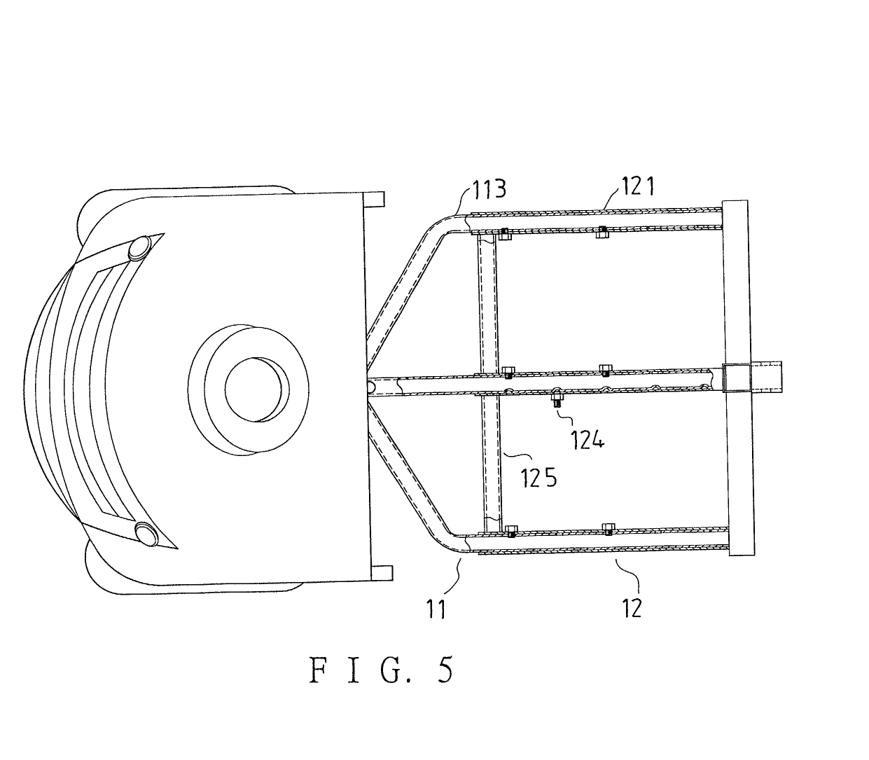

In assembling the frame 1, the parallel connecting tubes 113 of the front part 11 are passed into the corresponding connecting tubes 121 of the rear part 12, and moved to a proper position with the elastic button 124 snapping onto one of the locating recesses 115 of the front part 11 such that a desired length is provided for the frame 1. Then, bolts 123 are screwed through those of the screw holes 122 that are opposing the through holes 114 of the front part 11 so as to firmly connect the front part 11 and the rear part 12 together, as shown in FIGS. 2, 3 and 4.

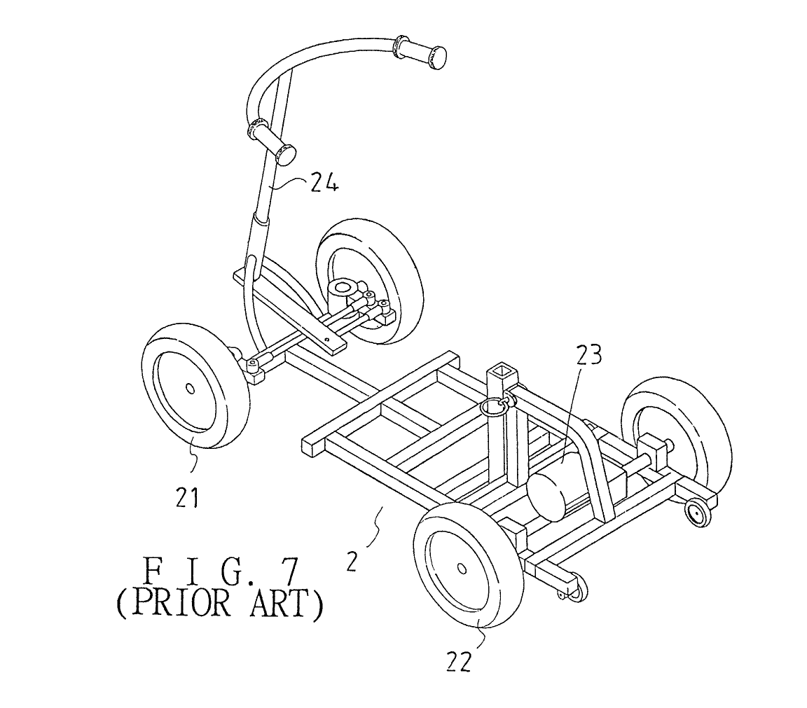

Referring to FIG. 6, nuts 1231 are fixed to the connecting tubes 121 of the rear part 12 by welding to enclose the screw holes 122 such that bolts 123 can be screwed therethrough to tightly come into contact with the connecting tubes 113 of the front part 11 for connecting both the front part 11 and the rear part 12 together without the through holes 114 being provided on the connecting tubes 11. In addition, the elastic button 124 can be provided in such a manner that it includes a steel ball 128 and a spring 129 biasing the steel ball 128 towards the inside of the middle connecting tube 121; thus, the steel ball 128 can snap onto the locating recesses 115 of the front part 11 when the front part 11 is moved in relation to the rear part 12 for the elastic button 124 to move to the locating recesses 115.

From the above description, it can be easily understood that the frame of a cart for the handicapped of the present invention has advantages as followings:

1. Including a front part, and a rear part, of which the position in relation to the front part can be changed, the frame can be provided with various lengths to meet the needs of users of different body size and accord with the regulations of different countries.

2. The cost of designing and production control is reduced because the manufacturers only have to produce front parts and rear parts of fixed dimensions in order to produce frames of different sizes.

3. The elastic button and the locating recess help the users and the manufactures easily find the correct position for the bolts to be able to connect the front part and the rear part together.

What is claimed is:

1. A frame of a cart for handicapped persons, comprising
a front part, said front part being provided for a handle, and front wheels of a cart to be connected to;
a rear part, said rear part being provided for a seat, a motor, and rear wheels of said cart to be connected to;
said front part having a plurality of parallel connecting tubes each being inserted into a corresponding one of parallel connecting tubes of said rear part; said connecting tubes of said rear part each having a plurality of screw holes arranged along a first side thereof for bolts to be screwed into to tightly come into contact with said front part in order to join said front part and said rear part together.

2. The frame of claim 1, wherein said connecting tubes of said front part has through holes formed along one side that opposes said first side of said connecting tubes of said rear part such that said bolts can be further passed into said through holes after same have been screwed through said screw holes for preventing said front part from moving relative to said rear part when both are joined together.

3. The frame of claim 2, wherein one of said connecting tubes of said front part is provided with a plurality of spaced locating recesses on an opposite side of said through holes, and a corresponding connecting tube of said rear part is provided with an elastic button such that said elastic button can snap onto one of said locating recesses when said through holes of said front part oppose side screw holes of said rear part.

4. The frame of claim 3, wherein said elastic button includes a steel ball, and a spring biasing said steel ball towards an inside of said corresponding connecting tube of said rear part.

5. The frame of claim 1, wherein nuts are secured to said connecting tubes of said rear part to enclose said screw holes for said bolts to be screwed into before same are screwed into said screw holes for joining said front part and said rear part together.
